(19) United States
(12) Patent Application Publication
(10) Pub. No.: US 2026/0255325 A1
(43) Pub. Date: Aug. 27, 2026

(54) BASE STATION, WIRELESS TERMINAL, COMMUNICATION SYSTEM, COMMUNICATION METHOD, AND PROGRAM

(71) Applicant: NEC Corporation, Minato-ku, Tokyo (JP)

(72) Inventors: Satoaki HAYASHI, Tokyo (JP); Yuhua CHEN, Tokyo (JP)

(73) Assignee: NEC Corporation, Minato-ku, Tokyo (JP)

(21) Appl. No.: 18/879,310

(22) PCT Filed: Jul. 21, 2023
(86) PCT No.: PCT/JP2023/026895

§ 371 Date: Dec. 27, 2024

(30) Foreign Application Priority Data
Jul. 28, 2022 (JP) 2022-121021

(51) Int. Cl. H04W 72/044; H04W 72/20

(52) U.S. Cl. CPC H04W 72/044; H04W 72/20

(57) ABSTRACT

An object is to provide a base station capable of realizing efficient scheduling of resources. A base station according to the present disclosure includes: a determination unit configured to determine whether a wireless terminal to which a wireless resource is to be allocated is a wireless terminal targeted for bi-directional scheduling of uplink data transmission and downlink data reception; and a communication unit configured to transmit, to the wireless terminal targeted for the bi-directional scheduling, information indicating wireless resources allocated to uplink data and downlink by using a common control message or control channel.

### Technical Field The present disclosure relates to a base station, a wireless terminal, a communication system, a communication method, and a program.

### Background Art

In recent years, extended reality (XR) services that provide experiences in a virtual world such as virtual reality (VR) and augmented reality (AR) have attracted attention. The market size of XR services is expected to expand in the future. Accordingly, in the 3rd Generation Partnership Project (registered trademark) (3GPP) that formulates wireless communication standards, communication standards for efficiently providing XR services have been studied.

Non Patent Literature 1 discloses that in an XR service in which uplink traffic and downlink traffic are simultaneously generated, it is effective to adjust communication timings of the uplink traffic and the downlink traffic in order to achieve power saving.

Non Patent Literature 2 discloses details of scheduling processing of allocating wireless resources to user equipment (UE) that performs uplink communication and downlink communication.

### Citation List

### Non Patent Literature

Non Patent Literature 1: 3GPP TSG RAN Meeting #96 Discussion on XR

Non Patent Literature 2: 3GPP TS 38.300 V 16.8.0 (2021-12)

### SUMMARY OF INVENTION

### Technical Problem

Non Patent Literature 2 discloses that a g NodeB (gNB) corresponding to a base station allocates a resource for receiving downlink data to a UE and notifies the UE of the allocated wireless resource by using a control message or a control channel. Further, Non Patent Literature 2 discloses that the gNB allocates a resource for transmitting uplink data to the UE and notifies the UE of the allocated wireless resource by using a control message or a control channel.

Here, in an XR service, in order to realize power saving, it is desired to efficiently schedule resources and make notification as compared with the scheduling processing method and the method of notifying the UE which are performed for each of uplink communication and downlink communication and disclosed in Non Patent Literature 2.

In view of the above-described problems, an object of the present disclosure is to provide a base station, a wireless terminal, a communication system, a communication method, and a program capable of realizing an efficient resource scheduling/notification method.

### Solution to Problem

A base station according to a first aspect of the present disclosure includes: a determination unit configured to determine whether a wireless terminal to which a wireless resource is to be allocated is a wireless terminal targeted for bi-directional scheduling of uplink data transmission and downlink data reception; and a communication unit configured to transmits, to the wireless terminal targeted for the bi-directional scheduling, information indicating wireless resources allocated to uplink and downlink by using a common control message or control channel.

A wireless terminal according to a second aspect of the present disclosure includes: a communication unit configured to receive information indicating wireless resources allocated to uplink and downlink by using a common control message or control channel; and a control unit configured to decide a wireless resource for transmitting the uplink data and a wireless resource for receiving the downlink data by using the information indicating the wireless resources notified by using the common control message or control channel.

A communication system according to a third aspect of the present disclosure includes: a base station that includes a determination unit configured to determine whether a wireless terminal to which a wireless resource is to be allocated is a wireless terminal targeted for bi-directional scheduling of uplink data transmission and downlink data reception, and a communication unit configured to transmits, to the wireless terminal targeted for the bi-directional scheduling, information indicating wireless resources allocated to uplink and downlink by using a common control message or control channel; and a wireless terminal that includes a communication unit configured to receive the information indicating wireless resources allocated to uplink and downlink by using the common control message or control channel, and a control unit configured to decide a wireless resource for transmitting the uplink data and a wireless resource for receiving the downlink data by using the information indicating the wireless resources notified by using the common control message or control channel.

A communication method according to a fourth aspect of the present disclosure includes: determining whether a wireless terminal to which a wireless resource is to be allocated is a wireless terminal targeted for bi-directional scheduling of uplink data transmission and downlink data reception; and transmitting, to the wireless terminal targeted for the bi-directional scheduling, information indicating wireless resources allocated to uplink and downlink by using a common control message or control channel.

A program according to a fifth aspect of the present disclosure causes a computer to execute: determining whether a wireless terminal to which a wireless resource is to be allocated is a wireless terminal targeted for bi-directional scheduling of uplink data transmission and downlink data reception; and transmitting, to the wireless terminal targeted for the bi-directional scheduling, information notification indicating wireless resources allocated to uplink and downlink by using a common control message or control channel.

### Advantageous Effects of Invention

According to the present disclosure, it is possible to provide a base station, a wireless terminal, a communication system, a communication method, and a program capable of realizing efficient resource scheduling/notification method.

### BRIEF DESCRIPTION OF DRAWINGS

FIG. 1 is a configuration diagram of a base station according to the present disclosure.

FIG. 2 is a configuration diagram of a wireless terminal according to the present disclosure.

FIG. 3 is a diagram illustrating a flow of communication processing executed in the base station according to the present disclosure.

FIG. 4 is a diagram illustrating a flow of communication processing executed in the wireless terminal according to the present disclosure.

FIG. 5 is a configuration diagram of a communication system according to the present disclosure.

FIG. 6 is a diagram illustrating a flow of application processing of bi-directional scheduling according to the present disclosure.

FIG. 7 is a diagram illustrating a flow of scheduling processing according to the present disclosure.

FIG. 8 is a diagram illustrating a flow of the scheduling processing according to the present disclosure.

FIG. 9 is a diagram illustrating a flow of the scheduling processing according to the present disclosure.

FIG. 10 is a configuration diagram of a base station and a gNB according to the present disclosure.

FIG. 11 is a configuration diagram of a wireless terminal and UE according to the present disclosure.

### EXAMPLE EMBODIMENTS

### First Example Embodiment

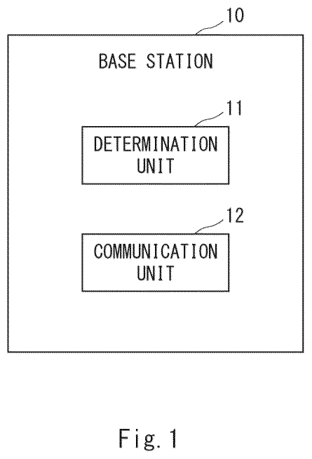

Hereinafter, a configuration example of a base station 10 will be described with reference to FIG. 1. The base station 10 may be a computer apparatus that operates in a case where a processor executes a program stored in a memory.

The base station may be, for example, a gNB defined in the 3rd Generation Partnership Project (3GPP).

The base station 10 includes a determination unit 11 and a communication unit 12. The determination unit 11 and the communication unit 12 may be software components or modules whose processing is carried out by causing the processor to execute the program stored in the memory. Alternatively, the determination unit 11 and the communication unit 12 may be hardware components such as circuits or chips. The base station 10 may be referred to as, for example, an access node.

The determination unit 11 determines whether the wireless terminal to which the wireless resource is to be allocated is a wireless terminal targeted for bi-directional scheduling of uplink data transmission and downlink data reception.

As the wireless resource, a wireless resource defined in 3GPP that defines New Radio (NR) may be used as a wireless communication standard. In 3GPP, it is defined that one frame is constituted by 10 subframes. One subframe has a length of 1 ms (milliseconds). Further, one slot has 14 symbols in the case of Normal CP, and has a variable length depending on sub-carrier spacing. For example, sub-carrier spacing is set to 15 kHz, 30 kHz, 60 kHz, 120 kHz, and 240 kHz. For example, in a case where sub-carrier spacing is 15 kHz, one subframe includes one slot. In a case where sub-carrier spacing is 30 kHz, one subframe includes two slots. In a case where sub-carrier spacing is 60 kHz, one subframe includes four slots. In a case where sub-carrier spacing is 120 kHz, one subframe includes eight slots. In a case where sub-carrier spacing is 240 kHz, one subframe includes sixteen slots.

A wireless resource having one slot or one symbol as a minimum unit is allocated to the wireless terminal, and data is transmitted and received. The wireless resource may be referred to as a resource block. The uplink data is data transmitted by the wireless terminal to the base station 10, and the downlink data is data transmitted by the base station 10 to the wireless terminal. The uplink data and the downlink data include control data and user data. The control data may be referred to as, for example, control (C)-plane data, and the user data may be referred to as user (U)-plane data.

The bi-directional scheduling may mean that, for example, the base station allocates, to the wireless terminal, a wireless resource regarding the uplink data and a wireless resource regarding the downlink data in association with each other. The allocation of wireless resources includes deciding transmission and reception timings of data in the wireless terminal, an amount of wireless resources to be used, and a location on a frequency axis. In other words, the bi-directional scheduling may mean that the wireless resource regarding the uplink data and the wireless resource regarding the downlink data are not independently allocated, but are allocated in association with each other. In still other words, in the bi-directional scheduling, the base station may not notify the wireless terminal of wireless resource scheduling for the uplink data and the downlink data by using different control messages or control channels. In this case, the bi-directional scheduling may mean that the base station notifies the wireless terminal by using a common control message or control channel. In other words, the bi-directional scheduling may mean that the base station simultaneously allocates, to one wireless terminal, the wireless resource regarding the uplink data and the wireless resource regarding the downlink data. Allocating the wireless resource regarding the uplink data and the wireless resource regarding the downlink data in association with each other may mean that in a case where any one of the wireless resources is decided, the other wireless resource is also uniquely decided. Here, scheduling of independently allocating the wireless resource regarding the uplink data and the wireless resource regarding the downlink data may be referred to as unidirectional scheduling or one-way scheduling.

The determination unit 11 may determine whether the wireless terminal is a target of the bi-directional scheduling, on the basis of a message received from the wireless terminal. The message received from the wireless terminal may include, for example, information indicating a target of the bi-directional scheduling. The information indicating a target of the bi-directional scheduling may be a parameter or a flag. Alternatively, the determination unit 11 may have in advance data for managing whether the wireless terminal is a target of the bi-directional scheduling. Alternatively, the determination unit 11 may determine whether the wireless terminal is a target of bi-directional scheduling, on the basis of a message received from a node disposed in a core network. The message received from the node disposed in the core network may include, for example, subscriber information regarding the wireless terminal.

The communication unit 12 transmits, to the wireless terminal targeted for the bi-directional scheduling, information indicating wireless resources allocated to the uplink and the downlink by using a common control message or control channel. The information indicating the wireless resources allocated to the uplink and the downlink by using the common control message or control channel may include, for example, period information indicating a period of any one of a timing of transmitting the uplink data and a timing of receiving the downlink data. Further, the information indicating the wireless resource may include time information indicating a time difference between the timing of transmitting the uplink data and the timing of receiving the downlink data. The communication unit 12 may transmit, to the wireless terminal, a message including the period information and the time information. Alternatively, the communication unit 12 may notify the wireless terminal of a wireless resource in which the period information and the time information are configured, in a protocol of a layer lower than a protocol layer used for transmitting the message including the period information and the time information. The wireless resource in which the period information and the time information are configured may be, for example, a wireless resource allocated to the wireless terminal to receive data.

The scheduling for the wireless terminal to periodically transmit the uplink data or periodically receive the downlink data may be referred to as semi persistent scheduling. The period information may be, for example, a transmission interval at which the wireless terminal transmits the uplink data, or a reception interval at which the wireless terminal receives the downlink data.

The time information indicating the time difference between the timing of transmitting the uplink data and the timing of receiving the downlink data may be, for example, information indicating a time from when the wireless terminal transmits the uplink data to when the wireless terminal receives the downlink data. Alternatively, the time information may be information indicating a time from when the wireless terminal receives the downlink data to when the wireless terminal transmits the uplink data.

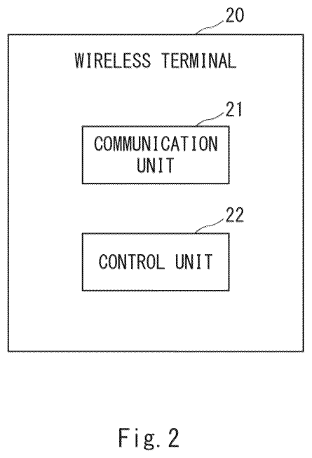

Next, a configuration example of the wireless terminal 20 will be described with reference to FIG. 2. The wireless terminal 20 may be a computer apparatus that operates in a case where a processor executes a program stored in a memory. The wireless terminal 20 may be a smartphone terminal, an Internet of Things (IOT) terminal, or the like. The wireless terminal 20 may be user equipment (UE) used as a generic term of a terminal apparatus in 3GPP.

The wireless terminal 20 includes a communication unit 21 and a control unit 22. The communication unit 21 and the control unit 22 may be software components or modules whose processing is executed by causing the processor to execute the program stored in the memory. Alternatively, the communication unit 21 and the control unit 22 may be hardware components such as circuits or chips.

The communication unit 21 receives, from the base station 10, the information indicating the wireless resources allocated to the uplink and the downlink by using the common control message or control channel. The information indicating the wireless resources allocated to the uplink and the downlink by using the common control message or control channel may include, for example, period information indicating a period of any one of a timing of transmitting the uplink data and a timing of receiving the downlink data.

Further, the information indicating the wireless resource may include time information indicating a time difference between the timing of transmitting the uplink data and the timing of receiving the downlink data.

The control unit 22 decides a wireless resource for transmitting the uplink data and a wireless resource for receiving the downlink data by using the information indicating the wireless resources allocated to the uplink and the downlink by using the common control message or control channel. For example, in a case where the period information indicates the timing of transmitting the uplink data, the control unit 22 decides the timing of transmitting the uplink data according to the period information. Further, the control unit 22 may decide the timing of receiving the downlink data by using the timing of transmitting the uplink data and the time information. The control unit 22 deciding the timing of transmitting the uplink data and the timing of receiving the downlink data may mean that the control unit 22 specifies wireless resources used for transmitting the uplink data and receiving the downlink data. That is, the communication unit 21 transmits the uplink data by using the wireless resource specified by the control unit 22, and receives the downlink data by using the wireless resource specified by the control unit 22.

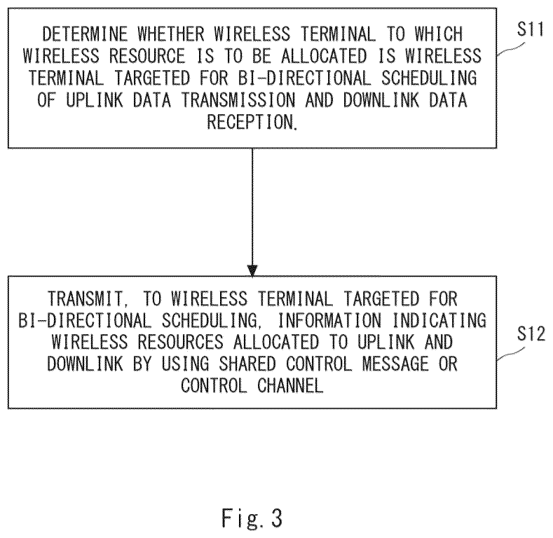

Next, a flow of communication processing executed in the base station 10 will be described with reference to FIG. 3. First, the determination unit 11 determines whether the wireless terminal to which the wireless resource is to be allocated is a wireless terminal targeted for bi-directional scheduling of uplink data transmission and downlink data reception (S11). Next, the communication unit 12 transmits, to the wireless terminal targeted for the bi-directional scheduling, information indicating the wireless resources allocated to the uplink and the downlink by using a common control message or control channel (S12).

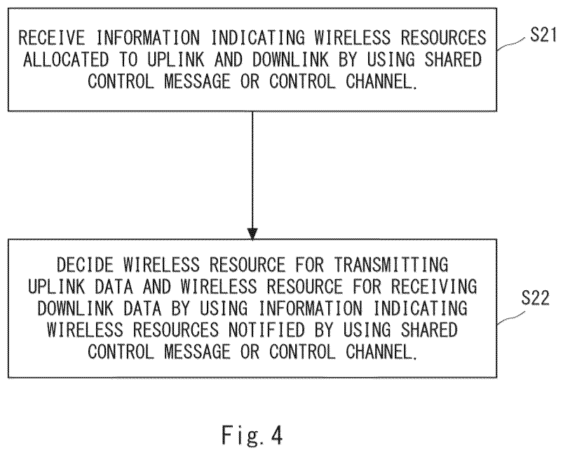

Next, a flow of communication processing executed in the wireless terminal 20 will be described with reference to FIG. 4. First, the communication unit 21 receives the information indicating the wireless resources allocated to the uplink and the downlink by using the common control message or control channel (S21). Next, the control unit 22 decides a wireless resource for transmitting the uplink data and a wireless resource for receiving the downlink data by using the information indicating wireless resources allocated to the uplink and the downlink by using the common control message or control channel (S22).

As described above, the base station 10 indicates the period of any one of the timing of transmitting the uplink data and the timing of receiving the downlink data, and indicates the time difference between the timing of transmitting the uplink data and the timing of receiving the downlink data.

Accordingly, the base station 10 can allocate, to the wireless terminal, the wireless resource regarding the uplink data and the wireless resource regarding the downlink data in association with each other. As a result, the number of control messages or control channels to be notified to the wireless terminal can be reduced as compared with a case where the base station 10 independently executes scheduling and notification of the wireless resource regarding the uplink data and the wireless resource regarding the downlink data. That is, it is possible to reduce a signaling overhead in a case where the base station 10 notifies the scheduling result regarding the wireless terminal.

### Second Example Embodiment

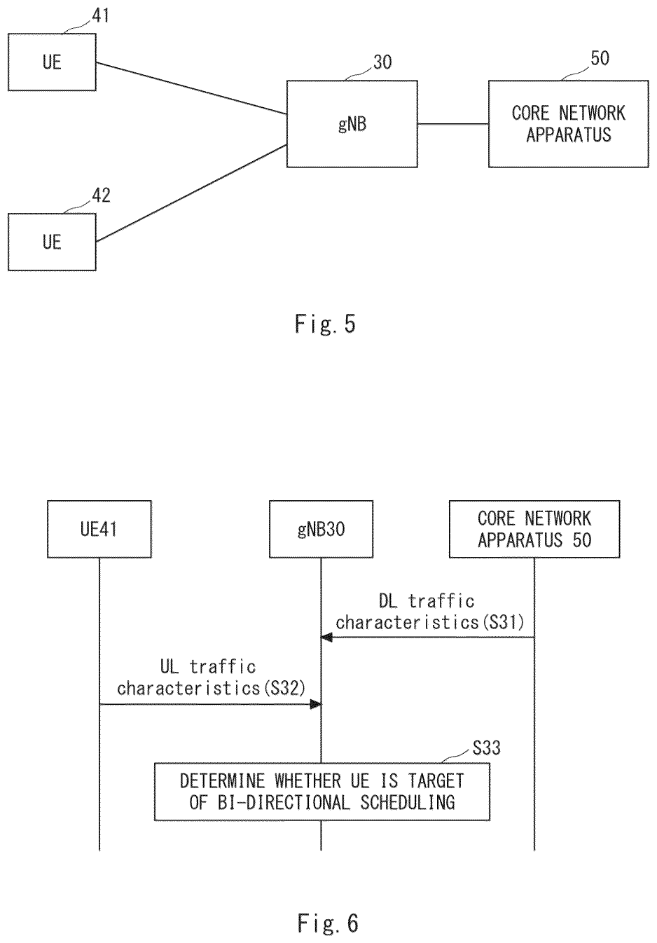

Next, a configuration example of a communication system will be described with reference to FIG. 5. The communication system in FIG. 5 illustrates a communication system defined in 3GPP. For example, the communication system includes a gNB 30, a UE 41, a UE 42, and a core network apparatus 50.

The gNB 30 corresponds to the base station 10 in FIG. 1. The gNB 30 is a base station that supports wireless communication using 5th Generation (5G) which is a wireless communication standard defined in 3GPP. The gNB 30 manages a cell which is a communication area in which wireless communication can be performed, and performs wireless communication with the UE 41 and the UE 42 existing in the cell by using 5G.

The UE 41 and the UE 42 may be, for example, wireless terminals that can use XR services. Each of the UE 41 and the UE 42 may be a smartphone terminal, a terminal worn by a person, or a headset type wireless terminal, for example.

The core network apparatus 50 is a node constituting a 5G core (5GC).

The nodes constituting the 5GC include, for example, an access and mobility management function (AMF) entity, a session management function (SMF) entity, a unified data management (UDM) entity, and the like.

Next, a flow of application processing of the bi-directional scheduling will be described with reference to FIG. 6. First, the core network apparatus 50 notifies the gNB 30 of downlink (DL) traffic characteristics (S31). The DL traffic characteristics may be included in, for example, a message defined in Next Generation Application Protocol (NGAP) and transmitted from the core network apparatus 50 to the gNB 30. The DL traffic characteristics may include, for example, values indicating a packet size, a packet arrival rate, a packet delay budget, a packet success rate requirement, a dual eye buffer model, and the like.

Further, the DL traffic characteristics may include information indicating a multi-streams DL traffic model. The information indicating the multi-streams DL traffic model may be, for example, information indicating I-frame and P-frame, information indicating video and audio/data, and information indicating FOV and omnidirectional stream. The information indicating the I-frame and the P-frame may include, for example, information indicating a slice-based traffic model or a group of picture (GOP) based traffic model.

Next, the UE 41 notifies the gNB 30 of uplink (UL) traffic characteristics (S32). The UL traffic characteristics may be included in, for example, a message defined in a radio resource control (RRC) protocol and transmitted from the UE 41 to the gNB 30. The message specified in the RRC protocol may be, for example, a RRC message.

The UL traffic characteristics may include values indicating a packet size, a packet arrival rate, a packet delay budget, and a packet success rate requirement. The UL traffic characteristics may further include information regarding a time between the DL traffic and the UL traffic. The information regarding the time between the DL traffic and the UL traffic may be, for example, a maximum time allowed from the reception of the DL traffic to the transmission of the UL traffic, or a maximum time allowed from the transmission of the UL traffic to the reception of the DL traffic. The information regarding the time between the DL traffic and the UL traffic may be determined according to, for example, QoS information regarding an application service used by the UE 41.

Alternatively, the information regarding the time between the DL traffic and the UL traffic may be determined according to the performance information of the UE 41. In addition, the DL traffic may also be referred to as downlink data, and the UP traffic may also be referred to as uplink data.

The gNB 30 may receive the UL traffic characteristics after receiving the DL traffic characteristics, or may receive the DL traffic characteristics after receiving the UL traffic characteristics.

Next, the gNB 30 determines whether the UE 41 is a target of the bi-directional scheduling (S33). In a case where the information regarding the time between the DL traffic and the UL traffic is included in the UL traffic characteristics, the gNB 30 may decide that the UE 41 is a target of the bi-directional scheduling. Alternatively, the UE 41 may include, in the UL traffic characteristics, a parameter or a flag explicitly indicating that the UE 41 is a target of the bi-directional scheduling. In this case, in a case where the parameter or the flag explicitly indicating that the UE 41 is a target of the bi-directional scheduling is included in the UL traffic characteristics, the gNB 30 may decide that the UE 41 is a target of the bi-directional scheduling. In the following description, content indicated by using a parameter may be indicated by using a flag. The bi-directional scheduling may be, for example, scheduling according to semi persistent scheduling (SPS) or configured scheduling (CS).

The SPS is specifically scheduling used by the gNB 30 to periodically transmit downlink data. Specifically, the CS is scheduling used for the UE 41 to periodically transmit the uplink data according to UL grant or configured grant

Furthermore, in a case where the UE 41 is a target of bi-directional scheduling, the gNB 30 decides period information indicating a period (periodicity) of data transmission in SPS or CS, information regarding a multiple of a period of uplink or downlink data transmission and reception based on the period information, and time information indicating a difference between a timing at which the UE 41 transmits the uplink data and a timing at which the UE 41 receives the downlink data. The time information may be referred to as a time offset or an offset. The period information and the time information may be indicated by using a time such as millisecond (ms) or second(s), or may be indicated by using the number of slots.

For example, the gNB 30 may decide the period of SPS according to the packet arrival rate included in the DL traffic characteristics. That is, the gNB 30 may decide the period of SPS according to an interval at which the downlink data to be transmitted to the UE 41 is received from the core network. For example, the gNB 30 may set the maximum value of the packet arrival rate as the period of SPS, may set the average value of the packet arrival rate as the period of SPS, or may set the minimum value of the packet arrival rate as the period of SPS. In addition, the gNB 30 may decide the period of CS according to the packet arrival rate included in the UL traffic characteristics. That is, the gNB 30 may decide the period of CS according to the interval at which the UE 41 transmits the uplink data. For example, the gNB 30 may set the maximum value of the packet arrival rate as the period of CS, may set the average value of the packet arrival rate as the period of CS, or may set the minimum value of the packet arrival rate as the period of CS.

In addition, the gNB 30 may decide the time information (time offset) according to the information regarding the time between the DL traffic and the UL traffic included in the UL traffic characteristics. For example, the gNB 30 may set, as the time offset, the time between the DL traffic and the UL traffic included in the UL traffic characteristics. Alternatively, the gNB 30 may use, as the time offset, a value obtained by adding a predetermined time to the time between the DL traffic and the UL traffic included in the UL traffic characteristics or a value obtained by subtracting a predetermined time from the time.

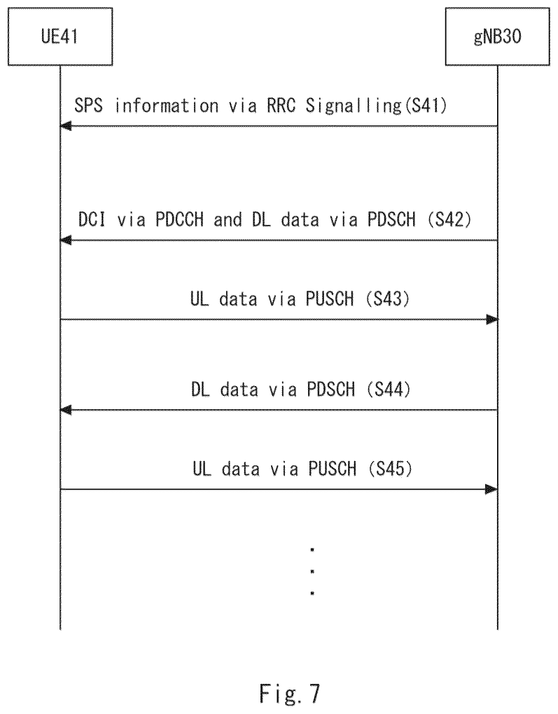

Next, a flow of the scheduling processing and notification to the UE will be described with reference to FIG. 7. It is assumed that the bi-directional scheduling application processing of FIG. 6 is executed before the scheduling processing illustrated in FIG. 7 is executed, and the UE 41 is determined to be a target of the bi-directional scheduling.

First, the gNB 30 transmits SPS information to the UE 41 via RRC layer signaling (S41). Transmitting SPS information to the UE 41 via RRC layer signaling may also be referred to as transmitting the RRC message including the SPS information to the UE 41. The SPS information may be referred to as SPS-Configuration or SPS-Config. The SPS information may include the information indicating that the UE 41 is a target of the bi-directional scheduling, the period information, and the time information.

For example, the period information indicates a period in which the UE 41 receives downlink data. The period in which the UE 41 receives the downlink data may be substantially the same as a period in which the gNB 30 transmits the downlink data. Further, the period information may indicate a period in which the UE 41 transmits the uplink data by using a multiple of the period in which the UE 41 receives the downlink data. For example, the period of transmitting the uplink data may be indicated as twice or three times the period of receiving the downlink data. The description that the period of transmitting the uplink data is twice the period of receiving the downlink data means that the number of times of transmitting the uplink data is ½ of the number of times of receiving the downlink data. “/” indicates a division or a fraction. The description that the period of transmitting the uplink data is three times the period of receiving the downlink data means that the number of times of transmitting the uplink data is ⅓ of the number of times of receiving the downlink data. In a case where the period of transmitting the uplink data is the same as the period of receiving the downlink data, the case is indicated as one time.

In addition, in a case where the transmission timing of the uplink data and the reception timing of the downlink data match, the time information may be 0.

Next, the gNB 30 transmits downlink control information (DCI) to the UE 41 via a physical downlink control channel (PDCCH), and transmits the downlink data to the UE 41 via a PDSCH (S42).

For the DCI transmitted via the PDCCH, for example, an extended DCI format 1_0 may be used. The general DCI format 1_0 is used for scheduling the PDSCH in the cell managed by the gNB. In addition, the general DCI format 1_0 is transmitted to the UE via the PDCCH along with a CRC scrambled by a CS-RNTI in a case where the SPS is performed. The general DCI format 1_0 includes an identifier for DCI format, frequency domain resource assignment, time domain resource assignment, a modulation and coding scheme, information indicating a resource indicator value (RIV), and the like regarding the downlink data. The frequency domain resource assignment and the time domain resource assignment are resources allocated to downlink data (downlink resources), and may be referred to as allocated downlink assignments. Information indicating the modulation and coding scheme and the resource indicator value (RIV) is a parameter used to control reception of downlink data. The downlink data is transmitted to the UE 41 via a physical downlink shared channel (PDSCH). The uplink data is transmitted from the UE 41 via a physical uplink shared channel (PUSCH). The parameter used to control the reception of downlink data may be, for example, a parameter indicating a modulation and coding scheme (MCS) or a parameter indicating a resource indicator value (RIV), and may further include other parameters. The RIV may be, for example, information indicating the number of resource blocks, the length of consecutively allocated resource blocks, information for identifying a first resource block among the allocated resource blocks, and the like. The UE 41 controls the reception of the PDSCH by using the received parameter. Controlling the reception of the PDSCH may include, for example, specifying a wireless resource (for example, a resource block) including the downlink data or in which the downlink data is configured, and further decoding the downlink data.

Here, in a case where packet sizes of the downlink data and the uplink data are substantially the same or have symmetry, parameters used to control the reception of the downlink data and the transmission of the uplink data may be the same.

In a case where the packet sizes of the downlink data and the uplink data are different, the parameter used to control the reception of the downlink data may be different from the parameter used to control the transmission of the uplink data. The case where the packet sizes of the downlink data and the uplink data are different may be, for example, a case where small data, a buffer status report (BSR), or the like is transmitted as the uplink data.

On the other hand, in the extended DCI format 1_0, the bi-directional scheduling is supported. Therefore, an Identifier for bi-directional scheduler (identifier for the bi-directional scheduler) may be included instead of the identifier for DCI format. For example, in a case where the value of a bit indicating the identifier for bi-directional scheduler is set to 1, the case may indicate that the bi-directional scheduling is executed. Further, in a case where the value of the bit indicating the identifier for bi-directional scheduler is set to 0, the case may indicate that the bi-directional scheduling is not executed or the scheduling of only the downlink data is executed. Alternatively, the value of the bit indicating that the bi-directional scheduling is executed may be 0, and the bit indicating that the scheduling of only the downlink data is executed may be 1.

Alternatively, on the assumption that bi-directional scheduling is performed, the case where the value of the bit indicating the identifier for bi-directional scheduler is set to 0 may indicate that the parameters used to control the reception of the downlink data and the transmission of the uplink data are the same. Further, the case where the value of the bit indicating the identifier for bi-directional scheduler is set to 1 may indicate that the parameter used to control the reception of the downlink data is different from the parameter used to control the transmission of the uplink data.

Further, in the extended DCI format 1_0, frequency domain resource assignment, time domain resource assignment, a modulation and coding scheme, and the like regarding the uplink data may be added to the information included in the general DCI format 1_0. The frequency domain resource assignment and the time domain resource assignment regarding the uplink data are resources allocated to the uplink data (uplink resources), and may be referred to as allocated uplink grants. The modulation and coding scheme and the like regarding the uplink data are parameters used to control the transmission of the uplink data. The UE 41 controls the transmission of the PUSCH by using the received parameter.

Controlling the reception of the PUSCH may include, for example, specifying a wireless resource (for example, a resource block) including the uplink data or in which the uplink data is configured, and further modulating the uplink data.

However, in a case where it is indicated that the parameters used to control the reception of the downlink data and the transmission of the uplink data are the same, the modulation and coding scheme, and the like regarding the uplink data may not be added. Alternatively, in a case where it is indicated that the parameters used to control the reception of the downlink data and the transmission of the uplink data are the same, the modulation and coding scheme, and the like regarding the uplink data may not be used or referred to in the UE 41.

The PDCCH including the DCI designates a CS-RNTI for identifying the UE 41, and activates configured downlink assignments and configured uplink grants. That is, the PDCCH designated with the CS-RNTI enables the resource allocated to the downlink data transmitted to the UE 41 via the SPS and the resource allocated to the uplink data transmitted by the UE 41. Accordingly, the UE 41 can receive the downlink data transmitted via the PDSCH. Further, the UE 41 may transmit the uplink data via the PUSCH. In addition, in a case where the transmission of the downlink data vis the SPS is stopped, the gNB 30 may transmit the PDCCH designated with the CS-RNTI to the UE 41 in order to deactivate the configured downlink assignments.

The PDCCH designated with the CS-RNTI may indicate that the allocated downlink assignments and the allocated uplink grants are reused for each period indicated by the period information. That is, after transmitting the PDCCH designated with the CS-RNTI to the UE 41 in step S42, the gNB 30 does not transmit the PDCCH designated with the CS-RNTI to the UE 41 except a case of deactivating the allocated downlink assignments thereafter. In step S42 and subsequent steps, the UE 41 can receive the downlink data transmitted via the PDSCH without receiving the PDCCH designated with the CS-RNTI. After step S42, the UE 41 repeatedly uses the parameter received in step S42 as the parameter used to control the reception of the downlink data.

Next, the UE 41 transmits the uplink data to the gNB 30 via the PUSCH (S43). The UE 41 may transmit the uplink data according to the SPS information received via the RRC layer signaling in step S41 and the allocated uplink grants received in step S42. That is, the UE 41 may transmit the uplink data at the timing decided by the period information and the time information included in the SPS information with reference to the timing at which the downlink data is received. In step S42 and subsequent steps, the UE 41 can transmit the uplink data via the PUSCH without receiving the PDCCH designated with the CS-RNTI. In step S42 and subsequent steps, the UE 41 repeatedly uses the parameter received in step S42 as the parameter used to control the transmission of the uplink data.

Next, the gNB 30 transmits the downlink data to the UE 41 via the physical downlink shared channel (PDSCH) (S44). At this time, the gNB 30 does not transmit the PDCCH designated with the CS-RNTI since it is indicated in step S42 that the allocated downlink assignments are reused in the reception of the downlink data in the UE 41.

Next, the UE 41 transmits the uplink data to the gNB 30 via the physical uplink shared channel (PUSCH) (S45). The UE 41 transmits the uplink data at the timing decided by the period information and the time information included in the SPS information with reference to the timing at which the downlink data is received.

After step S45, the same processing as steps S44 and S45 are repeated until the gNB 30 transmits, to the UE 41, the PDCCH for deactivating the allocated downlink assignments.

As described above, in the scheduling processing, the gNB 30 decides the uplink data transmission timing for the UE 41 that is a target of the bi-directional scheduling, with reference to the time information on the basis of the downlink data reception timing. Accordingly, the gNB 30 can associate the scheduling of the uplink data and the downlink data in the scheduling processing/notification method for the UE 41 that is a target of the bi-directional scheduling. As a result, as compared with a case where the scheduling regarding the uplink data and the scheduling regarding the downlink data are individually notified, an efficient scheduling/notification method can be realized from the viewpoint of power consumption, overhead reduction of a control message, a control channel, or the like, and the like.

### Third Example Embodiment

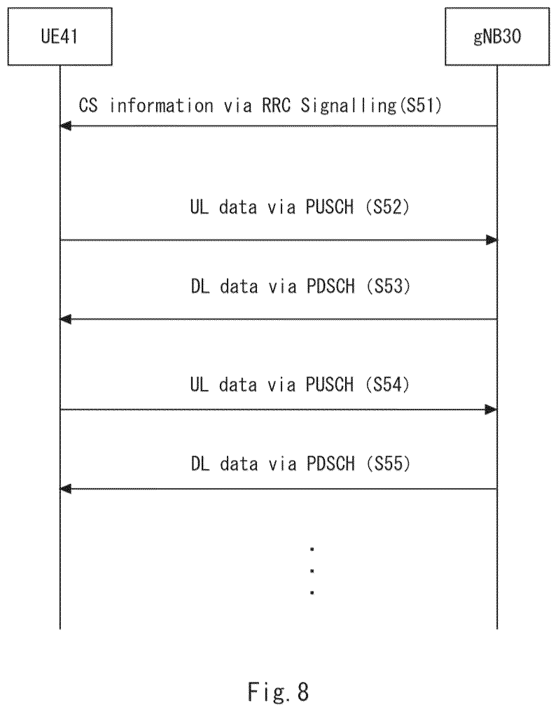

Next, a flow of the scheduling processing will be described with reference to FIG. 8. It is assumed that the bi-directional scheduling application processing of FIG. 6 is executed before the scheduling processing illustrated in FIG. 8 is executed, and the UE 41 is determined to be a target of the bi-directional scheduling.

First, the gNB 30 transmits CS information to the UE 41 via RRC layer signaling (S51). Transmitting CS information to the UE 41 via RRC layer signaling may also be referred to as transmitting the RRC message including the CS information to the UE 41. The CS information may include the information indicating that the UE 41 is a target of the bi-directional scheduling, the period information, the time information, and the resource information.

For example, the period information indicates a period in which the UE 41 transmits uplink data. Further, the period information may indicate a period in which the UE 41 receives the downlink data by using a multiple of the period at in which the UE 41 transmits the uplink data. For example, the period of receiving the downlink data may be indicated as twice or three times the period of transmitting the uplink data. In a case where the period of receiving the downlink data is the same as the period of transmitting the uplink data, the case is indicated as one time.

In addition, in a case where the transmission timing of the uplink data and the reception timing of the downlink data match, the time information may be 0.

The resource information may include allocated downlink assignments that are resources allocated to the downlink data and allocated uplink grants that are resources allocated to the uplink data.

The resource information may further include a parameter used to control the reception of the downlink data and the transmission of the uplink data in the UE 41.

Next, the UE 41 transmits the uplink data via the PUSCH (S52). The UE 41 may transmit the uplink data according to the CS information received via the RRC layer signaling in step S51. Specifically, the UE 41 transmits the uplink data according to the period information and the allocated uplink grants.

Next, the gNB 30 transmits the downlink data to the UE 41 via the PDSCH (S53). The UE 41 may receive the downlink data according to the CS information received via the RRC layer signaling in step S51. That is, the UE 41 may receive the downlink data according to the allocated downlink assignments at the timing decided by the period information and the time information included in the CS information with reference to the timing at which the uplink data is transmitted.

After step S53, processing similar to steps S52 and S53 is repeated.

As described above, in the scheduling processing, the timing at which the UE receives the downlink data is determined with reference to the timing at which the UE 41 transmits the uplink data. That is, the timing at which the UE 41 transmits the uplink data is associated with the timing at which the UE 41 receives the downlink data. In this way, the gNB 30 can associate the scheduling and notification of the uplink data and the downlink data in the scheduling processing/notification method for the UE 41 that is a target of the bi-directional scheduling.

### Fourth Example Embodiment

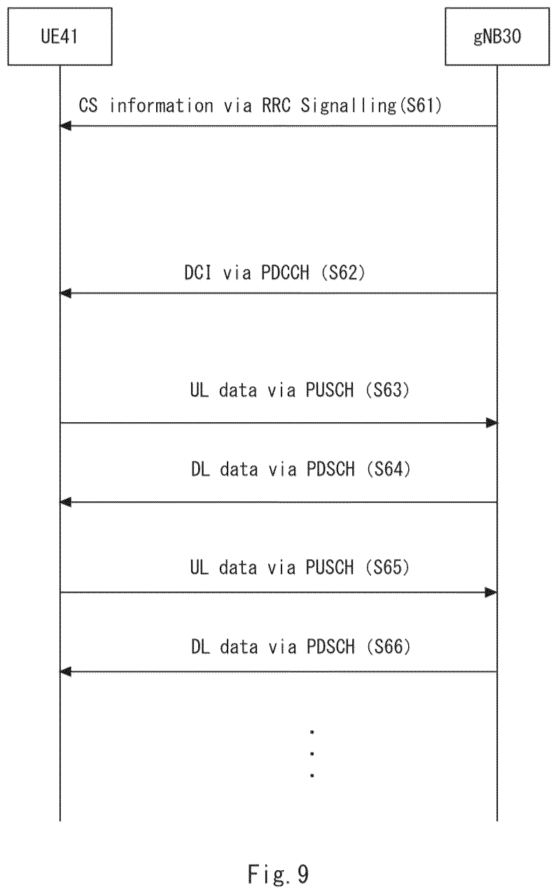

Next, a flow of the scheduling processing will be described with reference to FIG. 9. It is assumed that the bi-directional scheduling application processing of FIG. 6 is executed before the scheduling processing illustrated in FIG. 9 is executed, and the UE 41 is determined to be a target of the bi-directional scheduling.

First, the gNB 30 transmits CS information to the UE 41 via RRC layer signaling (S61). Transmitting CS information to the UE 41 via RRC layer signaling may also be referred to as transmitting the RRC message including the CS information to the UE 41. The CS information may include the information indicating that the UE 41 is a target of the bi-directional scheduling, the period information, and the time information.

Next, the GNB 30 transmits the DCI to the UE 41 via the PDCCH (S62).

For the DCI transmitted via the PDCCH, for example, an extended DCI format 0_1 may be used. A general DCI format 0_1 is used to indicate scheduling of the PUSCH or CG downlink feedback information (CG-DFI) in a cell managed by the gNB. In addition, the general DCI format 0_1 is transmitted to the UE via the PDCCH along with the CRC scrambled by the CS-RNTI in a case where CS is performed. The general DCI format 0_1 includes an identifier of DCI format, frequency domain resource assignment, time domain resource assignment, a modulation and coding scheme, and the like regarding the uplink data. The frequency domain resource assignment and time domain resource assignment correspond to allocated uplink grants.

On the other hand, in the extended DCI format 0_1, the bi-directional scheduling is supported. Therefore, an Identifier for bi-directional scheduler (identifier for the bi-directional scheduler) may be included instead of the identifier for DCI format. For example, in a case where the value of a bit indicating the identifier for bi-directional scheduler is set to 1, the case may indicate that the bi-directional scheduling is executed. Further, in a case where the value of the bit indicating the identifier for bi-directional scheduler is set to 0, the case may indicate that the bi-directional scheduling is not executed or the scheduling of only the uplink data is executed. Alternatively, the value of the bit indicating that the bi-directional scheduling is executed may be 0, and the bit indicating that the scheduling of only the uplink data is executed may be 1.

Alternatively, on the assumption that bi-directional scheduling is performed, the case where the value of the bit indicating the identifier for bi-directional scheduler is set to 0 may indicate that the parameters used to control the reception of the downlink data and the transmission of the uplink data are the same. Further, in a case where the value of the bit indicating the identifier for bi-directional scheduler is set to 1, the parameter used to control the reception of the downlink data may be different from the parameter used to control the transmission of the uplink data.

Further, in the extended DCI format 0_1, frequency domain resource assignment, time domain resource assignment, a modulation and coding scheme, and the like regarding the downlink data may be added to the information included in the general DCI format 0_1. The frequency domain resource assignment and time domain resource assignment regarding downlink data correspond to allocated downlink assignments. However, in a case where it is indicated that the parameters used to control the reception of the downlink data and the transmission of the uplink data are the same, the modulation and coding scheme, and the like regarding the downlink data may not be added.

Alternatively, the modulation and coding scheme and the like regarding the downlink data may not be used or referred to in the UE 41.

The PDCCH including the DCI designates a CS-RNTI for identifying the UE 41, and activates allocated uplink grants and allocated downlink assignments. That is, the PDCCH designated with the CS-RNTI enables the resource allocated to the uplink data transmitted by the UE 41 via the CS and the resource allocated to the downlink data received by the UE 41. Accordingly, the UE 41 can transmit the uplink data via the PUSCH and receive the downlink data via the PDSCH. In addition, in a case where the transmission of the uplink data via the CS is stopped, the gNB 30 may transmit the PDCCH designated with the CS-RNTI to the UE 41 in order to deactivate the allocated uplink grants.

The PDCCH designated with the CS-RNTI may indicate that the allocated uplink grants and the allocated downlink assignments are reused for each period indicated by the period information. That is, after transmitting the PDCCH designated with the CS-RNTI to the UE 41 in step S62, the gNB 30 does not transmit the PDCCH designated with the CS-RNTI to the UE 41 except a case of deactivating the allocated uplink grants thereafter. In step S62 and subsequent steps, the UE 41 can transmit the uplink data via the PUSCH without receiving the PDCCH designated with the CS-RNTI. In step S62 and subsequent steps, the UE 41 repeatedly uses the parameter received in step S62 as the parameter used to control the reception of the uplink data.

Next, the UE 41 transmits the uplink data to the gNB 30 via the PUSCH (S63). The UE 41 transmits the uplink data according to the period information included in the CS information and the enabled allocated uplink grants.

Next, the gNB 30 transmits the downlink data to the UE 41 via the PDSCH (S64). The UE 41 may receive the downlink data according to the CS information received via the RRC layer signaling in step S61 and the allocated downlink assignments received in step S62. That is, the UE 41 may receive the downlink data according to the allocated downlink assignments at the timing decided by the period information and the time information included in the CS information with reference to the timing at which the uplink data is transmitted.

In step S64 and subsequent steps, the UE 41 can transmit the downlink data via the PDSCH without receiving the PDCCH designated with the CS-RNTI. After step S62, the UE 41 repeatedly uses the parameter received in step S62 as the parameter used to control the reception of the downlink data.

After step S64, the same processing as steps S63 and S64 are repeated until the gNB 30 transmits, to the UE 41, the PDCCH for deactivating the allocated uplink grants.

As described above, as in the third example embodiment, in the scheduling processing according to a fourth example embodiment, the timing at which the UE receives the downlink data is determined with reference to the timing at which the UE 41 transmits the uplink data. In this way, the gNB 30 can associate the scheduling of the uplink data and the downlink data in the scheduling processing for the UE 41 that is a target of the bi-directional scheduling.

Here, an example in which the gNB 30 transmits the SPS information or the CS information to the UE 41 via the RRC layer signaling has been described in the second to fourth example embodiments, but the SPS information or the CS information may be transmitted to the UE 41 via the PDCCH. That is, in step S42 of FIG. 7 or step S62 of FIG. 9, the gNB 30 may transmit the information indicating that the UE 41 is a target of the bi-directional scheduling, the period information, the time information, and the resource information to the UE 41 via the PDCCH. The resource information may include a parameter used to control the reception of the downlink data and the transmission of the uplink data in the UE 41. In addition, the DCI transmitted via the PDCCH may further extend the extended DCI format 1_0. For example, in DC format 1_0 obtained by further extending the extended DCI format 1_0, the period information and the time information may be added to the extended DCI format 1_0.

Alternatively, in a case where the gNB 30 periodically transmits the PDCCH to the UE 41, the period information may not be included in the PDCCH. That is, the UE 41 decides the timing of receiving the downlink data and the timing of transmitting the uplink data each time the PDCCH is received.

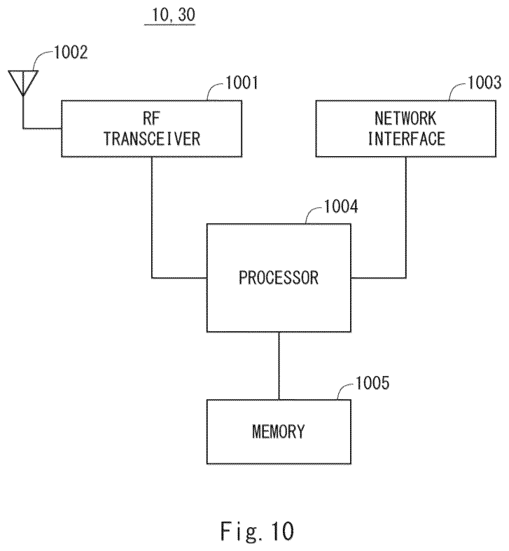

FIG. 10 is a block diagram illustrating a configuration example of the base station 10 and the gNB 30 (hereinafter, referred to as the base station 10 or the like). Referring to FIG. 10, the base station 10 or the like includes an RF transceiver 1001, a network interface 1003, a processor 1004, and a memory 1005. The RF transceiver 1001 performs analog RF signal processing to communicate with the UEs. The RF transceiver 1001 may include a plurality of transceivers. The RF transceiver 1001 is coupled with the antenna 1002 and the processor 1004. The RF transceiver 1001 receives modulated symbol data (or OFDM symbol data) from the processor 1004, generates a transmission RF signal, and supplies the transmission RF signal to the antenna 1002. Also, the RF transceiver 1001 generates a baseband reception signal on the basis of the reception RF signal received by the antenna 1002, and provides the baseband reception signal to the processor 1004.

The network interface 1003 is used to communicate with a network node (for example, other core network nodes). The network interface 1003 may include, for example, a network interface card (NIC) conforming to IEEE 802.3 series.

The processor 1004 performs data plane processing including digital baseband signal processing for wireless communication and control plane processing.

The processor 1004 may include a plurality of processors. For example, the processor 1004 may include a modem processor (for example, DSP) that performs digital baseband signal processing and a protocol stack processor (for example, CPU or MPU) that performs control plane processing.

The memory 1005 is configured by a combination of a volatile memory and a nonvolatile memory. The memory 1005 may include a plurality of physically independent memory devices. The volatile memory is, for example, a Static Random Access Memory (SRAM), a Dynamic RAM (DRAM), or a combination thereof. The nonvolatile memory is a masked Read Only Memory (MROM), an Electrically Erasable Programmable ROM (EEPROM), a flash memory, or a hard disk drive, or any combination thereof. The memory 1005 may include a storage disposed away from the processor 1004. In this case, the processor 1004 may access the memory 1005 through the network interface 1003 or an I/O interface (not illustrated).

The memory 1005 may store a software module (computer program) including a group of instructions and data for performing processing by the base station 10 or the like described in example embodiments as described above. In some implementations, the processor 1004 may be configured to perform the processing of the base station 10 or the like described in the example embodiments as described above by reading the software module from the memory 1005 and executing it.

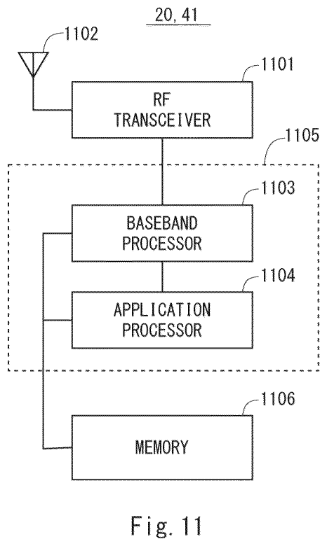

FIG. 11 is a block diagram illustrating a configuration example of the wireless terminal 20 and the UE 41 (hereinafter, referred to as the wireless terminal 20 or the like). A radio frequency (RF) transceiver 1101 performs analog RF signal processing to communicate with the access network node 20 or a gNB 51. The analog RF signal processing performed by the RF transceiver 1101 includes frequency up-conversion, frequency down-conversion, and amplification. The RF transceiver 1101 is coupled with an antenna 1102 and a baseband processor 1103. That is, the RF transceiver 1101 receives modulated symbol data (or OFDM symbol data) from the baseband processor 1103, generates a transmission RF signal, and supplies the transmission RF signal to the antenna 1102. In addition, the RF transceiver 1101 generates a baseband reception signal on the basis of the reception RF signal received by the antenna 1102 and provides the baseband reception signal to the baseband processor 1103.

The baseband processor 1103 performs digital baseband signal processing (data plane processing) for wireless communication and control plane processing. The digital baseband signal processing includes (a) data compression/restoration, (b) data segmentation/constellation, (c) generation/decomposition of a transmission format (transmission frame), (d) transmission path encoding/decoding, (e) modulation (symbol mapping)/demodulation, (f) generation of OFDM symbol data (baseband OFDM signal) by Inverse Fast Fourier Transform (IFFT), and the like. On the other hand, the control plane processing includes communication management of Layer 1, Layer 2, and Layer 3.

The baseband processor 1103 may include a modem processor (for example, digital signal processor (DSP)) that performs digital baseband signal processing and a protocol stack processor (for example, a central processing unit (CPU), or a micro processing unit (MPU)) that performs control plane processing. In this case, the protocol stack processor that performs the control plane processing may be shared with an application processor 1104 described later.

The application processor 1104 is also referred to as a CPU, an MPU, a microprocessor, or a processor core. The application processor 1104 may include a plurality of processors (a plurality of processor cores). The application processor 1104 implements various functions of the wireless terminal 20 and the like by executing a system software program (operating system (OS)) and various application programs (for example, a call application, a WEB browser, a mailer, a camera operation application, or a music playback application) read from the memory 1106 or a memory (not illustrated).

In some implementations, as indicated by a dashed line (1105) in FIG. 11, the baseband processor 1103 and the application processor 1104 may be integrated on one chip. In other words, the baseband processor 1103 and the application processor 1104 may be implemented as one system on chip (SoC) device 1105. The SoC device may also be referred to as a system large scale integration (LSI) or chipset.

The memory 1106 is a volatile memory, a nonvolatile memory, or a combination thereof. The memory 1106 may include a plurality of physically independent memory devices. The volatile memory is, for example, a Static Random Access Memory (SRAM), a Dynamic RAM (DRAM), or a combination thereof. The nonvolatile memory is a masked Read Only Memory (MROM), an Electrically Erasable Programmable ROM (EEPROM), a flash memory, or a hard disk drive, or any combination thereof. For example, the memory 1106 may include an external memory device accessible from the baseband processor 1103, the application processor 1104, and the SoC 1105. The memory 1106 may include an embedded memory device integrated within the baseband processor 1103, within the application processor 1104, or within the SoC 1105. Further, the memory 1106 may include a memory in a universal integrated circuit card (UICC).

The memory 1106 may store a software module (computer program) including a group of instructions and data for performing processing by the wireless terminal 20 or the like described in example embodiments as described above. In some implementations, the baseband processor 1103 or the application processor 1104 may be configured to perform processing of the wireless terminal 20 or the like described in the example embodiments as described above by reading the software module from the memory 1106 and executing it.

In the above-described example, the program includes a group of instructions (or software codes) for causing a computer to execute one or more functions described in the example embodiments in a case where the program is read by the computer. The program may be stored in a non-transitory computer-readable medium or a tangible storage medium. As an example and not by way of limitation, the computer-readable medium or the tangible storage medium includes a random-access memory (RAM), a read-only memory (ROM), a flash memory, a solid-state drive (SSD) or any other memory technology, a CD-ROM, a digital versatile disc (DVD), a Blu-ray (registered trademark) disc or any other optical disc storage, a magnetic cassette, a magnetic tape, and a magnetic disk storage or any other magnetic storage device. The program may be transmitted on a transitory computer-readable medium or a communication medium. By way of example, and not limitation, transitory computer-readable or communication media include electrical, optical, acoustic, or other forms of propagated signals.

Note that the technical ideas of the present disclosure are not limited to the above-described example embodiments, and can be appropriately modified without departing from the scope.

Some or all of the above-described example embodiments may be described as in the following Supplementary Notes, but are not limited to the following Supplementary Notes.

### Supplementary Note 1

A base station including:
a determination unit configured to determine whether a wireless terminal to which a wireless resource is to be allocated is a wireless terminal targeted for bi-directional scheduling of uplink data transmission and downlink data reception; and
a communication unit configured to transmit, to the wireless terminal targeted for the bi-directional scheduling, information indicating wireless resources allocated to uplink and downlink by using a common control message or control channel.

### Supplementary Note 2

The base station according to supplementary note 1, wherein the information indicating the wireless resources includes period information indicating a period of any one of a timing of transmitting uplink data and a timing of receiving downlink data, and time information indicating a time difference between the timing of transmitting the uplink data and the timing of receiving the downlink data.

### Supplementary Note 3

The base station according to supplementary note 2, wherein the period information indicates a timing at which the wireless terminal receives the downlink data, and a timing at which the wireless terminal transmits the uplink data is decided with reference to the timing at which the wireless terminal receives the downlink data.

### Supplementary Note 4

The base station according to supplementary note 2, wherein the period information indicates a timing at which the wireless terminal transmits the uplink data, and a timing at which the wireless terminal receives the downlink data is decided with reference to the timing at which the wireless terminal transmits the uplink data.

### Supplementary Note 5

The base station according to any one of supplementary notes 2 to 4, wherein the communication unit transmits, to the wireless terminal, resource information of the downlink data and the uplink data, and information used to control reception of the downlink data and transmission of the uplink data.

### Supplementary Note 6

The base station according to supplementary note 5, wherein the information used to control the reception of the downlink data and the transmission of the uplink data includes information indicating a frequency resource and a modulation and coding scheme (MCS) common to the reception of the downlink data and the transmission of the uplink data.

### Supplementary Note 7

The base station according to supplementary note 5 or 6, wherein the communication unit transmits, to the wireless terminal, a radio resource control (RRC) message including the period information and the time information, and transmits, to the wireless terminal via a PDCCH, the resource information of the downlink data and the uplink data and the information used to control the reception of the downlink data and the transmission of the uplink data.

### Supplementary Note 8

The base station according to supplementary note 5 or 6, wherein the communication unit transmits, via a PDCCH, the period information, the time information, the resource information of the downlink data and the uplink data, and the information used to control the reception of the downlink data and the transmission of the uplink data.

### Supplementary Note 9

The base station according to any one of supplementary notes 3 to 6, wherein
the communication unit transmits, to the wireless terminal, a radio resource control (RRC) message including the period information, the time information, resource information of the downlink data and the uplink data, and information used to control reception of the downlink data and transmission of the uplink data.

### Supplementary Note 10

A wireless terminal including:
a communication unit configured to receive information indicating wireless resources allocated to uplink and downlink by using a common control message or control channel; and
a control unit configured to decide a wireless resource for transmitting uplink data and a wireless resource for receiving downlink data by using the information indicating the wireless resources notified by using the common control message or control channel.

### Supplementary Note 11

The wireless terminal according to supplementary note 10, wherein the information indicating the wireless resources includes period information indicating a period of any one of a timing of transmitting uplink data and a timing of receiving downlink data, and time information indicating a time difference between the timing of transmitting the uplink data and the timing of receiving the downlink data.

### Supplementary Note 12

The wireless terminal according to supplementary note 11, wherein the period information indicates a timing at which the wireless terminal receives the downlink data, and the control unit decides the timing of transmitting the uplink data with reference to the timing at which the wireless terminal receives the downlink data.

### Supplementary Note 13

The wireless terminal according to supplementary note 11, wherein the period information indicates a timing at which the wireless terminal transmits the uplink data, and
the control unit decides the timing of receiving the downlink data with reference to the timing at which the wireless terminal transmits the uplink data.

### Supplementary Note 14

The wireless terminal according to any one of supplementary notes 11 to 13, wherein
the communication unit receives, from a base station, a radio resource control (RRC) message including the period information and the time information, and
the control unit decides the timing of transmitting the uplink data and the timing of receiving the downlink data on the basis of the period information and the time information.

### Supplementary Note 15

The wireless terminal according to any one of supplementary notes 11 to 13, wherein
the communication unit receives, via a PDCCH from a base station, a radio resource control (RRC) message including the period information and the time information, and
the control unit decides the timing of transmitting the uplink data and the timing of receiving the downlink data on the basis of the period information and the time information.

### Supplementary Note 16

A communication system including:
a base station that includes a determination unit configured to determine whether a wireless terminal to which a wireless resource is to be allocated is a wireless terminal targeted for bi-directional scheduling of uplink data transmission and downlink data reception, and a communication unit configured to transmit, to the wireless terminal targeted for the bi-directional scheduling, information indicating wireless resources allocated to uplink and downlink by using a common control message or control channel; and
a wireless terminal that includes a communication unit configured to receive the information indicating wireless resources allocated to uplink and downlink by using the common control message or control channel, and a control unit configured to decide a wireless resource for transmitting uplink data and a wireless resource for receiving downlink data by using the information indicating the wireless resources notified by using the common control message or control channel.

### Supplementary Note 17

The communication system according to supplementary note 16, wherein the base station transmits, to the wireless terminal, resource information of the downlink data and the uplink data, and information used to control reception of the downlink data and transmission of the uplink data.

### Supplementary Note 18

A communication method executed by a base station, including:
determining whether a wireless terminal to which a wireless resource is to be allocated is a wireless terminal targeted for bi-directional scheduling of uplink data transmission and downlink data reception; and
transmitting, to the wireless terminal targeted for the bi-directional scheduling, information indicating wireless resources allocated to uplink and downlink by using a common control message or control channel.

### Supplementary Note 19

The communication method according to supplementary note 18, wherein the information indicating the wireless resources includes period information indicating a period of any one of a timing of transmitting uplink data and a timing of receiving downlink data, and time information indicating a time difference between the timing of transmitting the uplink data and the timing of receiving the downlink data.

### Supplementary Note 20

The communication method according to supplementary note 19, wherein the period information indicates a timing at which the wireless terminal receives the downlink data, and a timing at which the wireless terminal transmits the uplink data is decided with reference to the timing at which the wireless terminal receives the downlink data.

### Supplementary Note 21

The communication method according to supplementary note 19, wherein the period information indicates a timing at which the wireless terminal transmits the uplink data, and a timing at which the wireless terminal receives the downlink data is decided with reference to the timing at which the wireless terminal transmits the uplink data.

### Supplementary Note 22

The communication method according to any one of supplementary notes 19 to 21, wherein in a case where the information indicating the wireless resources is transmitted, resource information of the downlink data and the uplink data, and information used to control reception of the downlink data and transmission of the uplink data are transmitted to the wireless terminal.

### Supplementary Note 23

The communication method according to supplementary note 22, wherein the information used to control the reception of the downlink data and the transmission of the uplink data includes information indicating a frequency resource and a modulation and coding scheme (MCS) common to the reception of the downlink data and the transmission of the uplink data.

### Supplementary Note 24

The communication method according to supplementary note 22 or 23, wherein in a case where the information indicating the wireless resources is transmitted, a radio resource control (RRC) message including the period information and the time information is transmitted to the wireless terminal, and the resource information of the downlink data and the uplink data and the information used to control the reception of the downlink data and the transmission of the uplink data are transmitted to the wireless terminal via a PDCCH.

### Supplementary Note 25

The communication method according to supplementary note 22 or 23, wherein in a case where the information indicating the wireless resources is transmitted, the period information, the time information, the resource information of the downlink data and the uplink data, and the information used to control the reception of the downlink data and the transmission of the uplink data are transmitted via a PDCCH.

### Supplementary Note 26

The communication method according to any one of supplementary notes 20 to 23, wherein in a case where the information indicating the wireless resources is transmitted, a radio resource control (RRC) message including the period information, the time information, resource information of the downlink data and the uplink data, and information used to control reception of the downlink data and transmission of the uplink data is transmitted to the wireless terminal.

### Supplementary Note 27

A communication method executed in a wireless terminal, including:
receiving information indicating wireless resources allocated to uplink and downlink by using a common control message or control channel; and
deciding a wireless resource for transmitting uplink data and a wireless resource for receiving downlink data by using the information indicating the wireless resources notified by using the common control message or control channel.

### Supplementary Note 28

The communication method according to supplementary note 27, wherein the information indicating the wireless resources includes period information indicating a period of any one of a timing of transmitting uplink data and a timing of receiving downlink data, and time information indicating a time difference between the timing of transmitting the uplink data and the timing of receiving the downlink data.

### Supplementary Note 29

The communication method according to supplementary note 28, wherein
the period information indicates a timing at which the wireless terminal receives the downlink data, and
in a case where the wireless resources are decided, the timing of transmitting the uplink data is decided with reference to the timing at which the wireless terminal receives the downlink data.

### Supplementary Note 30

The communication method according to supplementary note 28, wherein
the period information indicates a timing at which the wireless terminal transmits the uplink data, and
in a case where the wireless resources are decided, the timing of receiving the downlink data is decided with reference to the timing at which the wireless terminal transmits the uplink data.

### Supplementary Note 31

The communication method according to any one of supplementary notes to 30, wherein
in a case where the information indicating the wireless resources is received, a radio resource control (RRC) message including the period information and the time information is received from a base station, and
in a case where the wireless resources are decided, the timing of transmitting the uplink data and the timing of receiving the downlink data are decided on the basis of the period information and the time information.

### Supplementary Note 32

The communication method according to any one of supplementary notes to 30, wherein
in a case where the information indicating the wireless resources is received, a radio resource control (RRC) message including the period information and the time information is received via a PDCCH from a base station, and
in a case where the wireless resources are decided, the timing of transmitting the uplink data and the timing of receiving the downlink data are decided on the basis of the period information and the time information.

### Supplementary Note 33

A program for causing a computer to execute:
determining whether a wireless terminal to which a wireless resource is to be allocated is a wireless terminal targeted for bi-directional scheduling of uplink data transmission and downlink data reception; and
transmitting, to the wireless terminal targeted for the bi-directional scheduling, information indicating wireless resources allocated to uplink and downlink by using a common control message or control channel.

### Supplementary Note 34

The program according to supplementary note 33, wherein the information indicating the wireless resources includes period information indicating a period of any one of a timing of transmitting uplink data and a timing of receiving downlink data, and time information indicating a time difference between the timing of transmitting the uplink data and the timing of receiving the downlink data.

### Supplementary Note 35

The program according to supplementary note 34, wherein the period information indicates a timing at which the wireless terminal receives the downlink data, and a timing at which the wireless terminal transmits the uplink data is decided with reference to the timing at which the wireless terminal receives the downlink data.

### Supplementary Note 36

The program according to supplementary note 34, wherein the period information indicates a timing at which the wireless terminal transmits the uplink data, and a timing at which the wireless terminal receives the downlink data is decided with reference to the timing at which the wireless terminal transmits the uplink data.

### Supplementary Note 37

The program according to any one of supplementary notes 34 to 36, the program for causing the computer to execute: transmitting, in a case where the information indicating the wireless resources is transmitted, to the wireless terminal, resource information of the downlink data and the uplink data, and information used to control reception of the downlink data and transmission of the uplink data.

### Supplementary Note 38

The program according to supplementary note 37, wherein the information used to control the reception of the downlink data and the transmission of the uplink data includes information indicating a frequency resource and a modulation and coding scheme (MCS) common to the reception of the downlink data and the transmission of the uplink data.

### Supplementary Note 39

The program according to supplementary note 37 or 38, the program for causing the computer to execute: transmitting, in a case where the information indicating the wireless resources is transmitted, to the wireless terminal, a radio resource control (RRC) message including the period information and the time information, and transmits, to the wireless terminal via a PDCCH, the resource information of the downlink data and the uplink data and the information used to control the reception of the downlink data and the transmission of the uplink data.

### Supplementary Note 40

The program according to supplementary note 37 or 38, the program for causing the computer to execute: transmitting, in a case where the information indicating the wireless resources is transmitted, via a PDCCH, the period information, the time information, the resource information of the downlink data and the uplink data, and the information used to control the reception of the downlink data and the transmission of the uplink data.

### Supplementary Note 41

The program according to any one of supplementary notes 35 to 38, wherein
in a case where the information indicating the wireless resources is transmitted, a radio resource control (RRC) message including the period information, the time information, resource information of the downlink data and the uplink data, and information used to control reception of the downlink data and transmission of the uplink data is transmitted to the wireless terminal.

### Supplementary Note 42

A program for causing a computer to execute:
receiving information indicating wireless resources allocated to uplink and downlink by using a common control message or control channel; and
deciding a wireless resource for transmitting uplink data and a wireless resource for receiving downlink data by using the information indicating the wireless resources notified by using the common control message or control channel.

### Supplementary Note 43

The program according to supplementary note 42, wherein the information indicating the wireless resources includes period information indicating a period of any one of a timing of transmitting uplink data and a timing of receiving downlink data, and time information indicating a time difference between the timing of transmitting the uplink data and the timing of receiving the downlink data.

### Supplementary Note 44

The program according to supplementary note 43, wherein the period information indicates a timing at which the wireless terminal receives the downlink data, the program for causing the computer to execute:

deciding, in a case where the wireless resources are decided, the timing of transmitting the uplink data with reference to the timing at which the wireless terminal receives the downlink data.

### Supplementary Note 45

The program according to supplementary note 43, wherein
the period information indicates a timing at which the wireless terminal transmits the uplink data, the program for causing the computer to execute:
deciding, in a case where the wireless resources are decided, the timing of receiving the downlink data with reference to the timing at which the wireless terminal transmits the uplink data.

### Supplementary Note 46

The program according to any one of supplementary notes 43 to 45, the program for causing the computer to execute:
receiving, in a case where the information indicating the wireless resources is received, from a base station, a radio resource control (RRC) message including the period information and the time information, and
deciding, in a case where the wireless resources are decided, the timing of transmitting the uplink data and the timing of receiving the downlink data on the basis of the period information and the time information.

### Supplementary Note 47

The program according to any one of supplementary notes 43 to 45, the program for causing the computer to execute:
receiving, in a case where the information indicating the wireless resources is received, via a PDCCH from a base station, a radio resource control (RRC) message including the period information and the time information, and
deciding, in a case where the wireless resources are decided, the timing of transmitting the uplink data and the timing of receiving the downlink data on the basis of the period information and the time information.

Note that the technical ideas of the present disclosure are not limited to the above-described example embodiments, and can be appropriately modified without departing from the scope.

Although the present disclosure has been described with reference to the example embodiments, the present disclosure is not limited to the example embodiments described above. Various modifications that can be understood by those skilled in the art can be made to the configurations and details of the present disclosure within the scope of the present disclosure. Then, each example embodiment can be appropriately combined with another example embodiment.

Each drawing is merely illustrative for describing one or more example embodiments. Each drawing is not associated with only one specific example embodiment, but may be associated with one or more other example embodiments. As one of ordinary skill in the art will appreciate, various features or steps described with reference to any one of the drawings may be combined with features or steps shown in one or more other drawings, for example, to create an example embodiment not explicitly illustrated or described. All of the features or steps shown in any one of the drawings for describing example embodiments are not necessarily mandatory, and some features or steps may be omitted. The order of the steps described in any drawing may be changed as appropriate.

This application claims priority based on Japanese Patent Application No. 2022-121021 filed on Jul. 28, 2022, the entire disclosure of which is incorporated herein.

### Reference Signs List

10 BASE STATION
11 DETERMINATION UNIT
12 COMMUNICATION UNIT
20 WIRELESS TERMINAL
21 COMMUNICATION UNIT
22 CONTROL UNIT
30 gNB
41 UE
42 UE
50 CORE NETWORK APPARATUS

What is claimed is:

1-9. (canceled)

10. A wireless terminal comprising:
at least one memory storing instructions; and
at least one processor configured to execute the instructions to,
receive information indicating wireless resources allocated to uplink and downlink by using a common control message or control channel; and
decide a wireless resource for transmitting uplink data and a wireless resource for receiving downlink data by using the information indicating the wireless resources notified by using the common control message or control channel.

11-17. (canceled)

18. A communication method executed by a base station, comprising:
determining whether a wireless terminal to which a wireless resource is to be allocated is a wireless terminal targeted for bi-directional scheduling of uplink data transmission and downlink data reception; and
transmitting, to the wireless terminal targeted for the bi-directional scheduling, information indicating wireless resources allocated to uplink and downlink by using a common control message or control channel.

19. A communication method executed in a wireless terminal, comprising:
receiving information indicating wireless resources allocated to uplink and downlink by using a common control message or control channel; and
deciding and deciding a wireless resource for transmitting uplink data and a wireless resource for receiving downlink data by using the information indicating the wireless resources notified by using the common control message or control channel.

20. (canceled)

21. The communication method according to claim 18, wherein the information indicating the wireless resources includes period information indicating a period of any one of a timing of transmitting uplink data and a timing of receiving downlink data, and time information indicating a time difference between the timing of transmitting the uplink data and the timing of receiving the downlink data.

22. The communication method according to claim 21, wherein the period information indicates a timing at which the wireless terminal receives the downlink data, and a timing at which the wireless terminal transmits the uplink data is decided with reference to the timing at which the wireless terminal receives the downlink data.

23. The communication method according to claim 21, wherein the period information indicates a timing at which the wireless terminal transmits the uplink data, and a timing at which the wireless terminal receives the downlink data is decided with reference to the timing at which the wireless terminal transmits the uplink data.

24. The communication method according to claim 21, wherein in a case where the information indicating the wireless resources is transmitted, resource information of the downlink data and the uplink data, and information used to control reception of the downlink data and transmission of the uplink data are transmitted to the wireless terminal.

25. The communication method according to claim 24, wherein the information used to control the reception of the downlink data and the transmission of the uplink data includes information indicating a frequency resource and a modulation and coding scheme (MCS) common to the reception of the downlink data and the transmission of the uplink data.

26. The communication method according to claim 24, wherein in a case where the information indicating the wireless resources is transmitted, a radio resource control (RRC) message including the period information and the time information is transmitted to the wireless terminal, and the resource information of the downlink data and the uplink data and the information used to control the reception of the downlink data and the transmission of the uplink data are transmitted to the wireless terminal via a PDCCH.

27. The communication method according to claim 25, wherein in a case where the information indicating the wireless resources is transmitted, the period information, the time information, the resource information of the downlink data and the uplink data, and the information used to control the reception of the downlink data and the transmission of the uplink data are transmitted via a PDCCH.

28. The communication method according to claim 22, wherein in a case where the information indicating the wireless resources is transmitted, a radio resource control (RRC) message including the period information, the time information, resource information of the downlink data and the uplink data, and information used to control reception of the downlink data and transmission of the uplink data is transmitted to the wireless terminal.

29. The communication method according to claim 19, wherein the information indicating the wireless resources includes period information indicating a period of any one of a timing of transmitting uplink data and a timing of receiving downlink data, and time information indicating a time difference between the timing of transmitting the uplink data and the timing of receiving the downlink data.

30. The communication method according to claim 29, wherein
the period information indicates a timing at which the wireless terminal receives the downlink data, and
in a case where the wireless resources are decided, the timing of transmitting the uplink data is decided with reference to the timing at which the wireless terminal receives the downlink data.

31. The communication method according to claim 29, wherein
the period information indicates a timing at which the wireless terminal transmits the uplink data, and
in a case where the wireless resources are decided, the timing of receiving the downlink data is decided with reference to the timing at which the wireless terminal transmits the uplink data.

32. The communication method according to claim 29, wherein
in a case where the information indicating the wireless resources is received, a radio resource control (RRC) message including the period information and the time information is received from a base station, and
in a case where the wireless resources are decided, the timing of transmitting the uplink data and the timing of receiving the downlink data are decided on the basis of the period information and the time information.

33. The communication method according to claim 29, wherein
in a case where the information indicating the wireless resources is received, a radio resource control (RRC) message including the period information and the time information is received via a PDCCH from a base station, and
in a case where the wireless resources are decided, the timing of transmitting the uplink data and the timing of receiving the downlink data are decided on the basis of the period information and the time information.
